(19) United States
(12) Patent Application Publication
(10) Pub. No.: US 2012/0187166 A1
(43) Pub. Date: Jul. 26, 2012

(54) Motorcycle back rest full size flag, flag holder

(76) Inventor: David Lee Cook, Loveland, CO (US)

(21) Appl. No.: 12/931,031

(22) Filed: Jan. 24, 2011

(51) Int. Cl. B62J 11/00

(52) U.S. Cl. 224/413

(57) ABSTRACT

A flagpole support for motorcycles—a tube or tubes bolted to a plate or brackets which are bolted or clipped to the existing standard back rest support bar or tube of a motorcycle. The tubes are held in place on plate or brackets by a bolts or other mechanism through the bottom of the tube, and a clamp or clip above. The plate or brackets then bolted or clipped to the back rest frame support of the motorcycle. The tube positions are completely adjustable. An attachment bar which clips onto the support tubes under a rear luggage box. A back rest support mount with legs which fit into the standard back rest mounts on motorcycles. Onto this support are attached plates top and bottom through which the tubes are secured on the back side and a plate grooved for an adjustable back rest pad on the front side.

I claim priority of provisional application Ser. No. 61/336,002, dated Jan. 14, 2010, titled: Adjustable Backrest

### DESCRIPTION

Flag holders have been existent for centuries. Flag holders have been patented for a long time, as demonstrated in U.S. Pat. No. 6,402,116. Vehicle flag holder patents exist as U.S. patent application 20030004473 attests. Motorcycle flag holder patents also exist as patent application 20060118693 shows.

However, the present invention relates to flag holders for full size flags attached to the existing standard motorcycle backrest support frame, attached to a herein invented substitute for the standard backrest support frame or attaching to a herein invented tube or rod frame which attaches to the luggage box support tubes, of a motorcycle. The device makes it possible to easily attach or remove a flag holder from a motorcycle back rest support frame, back rest support brackets, or luggage box frame quickly and with minimal effort.

The invention allows single or multiple flag pole holder tubes to be easily attached or removed and the splay of the flags to be infinitely adjustable in position.

Prior art provides for the attachment of very small flags with a bracket to attach to luggage bars or axels. Also it provides for full size flags to be attached to a mount secured in a trailer hitch. In some cases the flag holder and pole are an integral part of the invention. In This invention, the flag holder is attached uniquely to the motorcycle unlike any prior art, and the flag pole is not part of the invention.

In addition, the flag holder attaches to a standard motorcycle part, the back rest, or it substitutes for a back rest and makes the back rest pad adjustable up and down, or it attaches uniquely to the framing for a luggage box.

Thus, this motorcycle flag holder uniquely solves the problem of easily and quickly switching flags, showing full size flags, and attaching them to a motorcycle quickly and easily and providing for the flag holder to be quickly and easily installed and removed from a back rest position. It allows the adjustment of the display quickly and easily as well.

### SUMMERY OF THE INVENTION

A flagpole support for the attachment of flags to the back rest support, back rest support brackets, or luggage box support tubes of a motorcycle. It additionally provides for the attachment and infinite adjustment of flag pole insertion tubes, the use of from one tube to several. It additionally makes it possible to adjust the display of the flags wider or narrower, splayed, or un-splayed.

The flag holder starts with either a set of brackets, a plate, or a frame, to which are attached one or multiple flag holder tubes which hold the flag poles. These tubes are held to the brackets, or plate or frame with bolts or clips allowing multiple tubes to be added at will. A bolt through the bottom of each tube holds it in place while preventing the flag pole from falling through the tube and holds the tube to the bracket, plate, or frame. An upper clamp holds each tube to the bracket, plate or frame and solidifies it's position in the tube array. Since the brackets, plates or frame used are grooved along their parts and bolts are solid and strong enough to take highway speeds and an occasional catching of the flag pole on the garage door. The basic units attach to the existing backrest of the motorcycle. The framework unit allows the multi grooved adjustable back rest pad mounting plate, and the luggage box mounting bar allows the bracket and plate flag holders to be mounted behind the luggage box.

### BRIEF DESCRIPTION OF THE DRAWINGS AND PICTURES

FIG. 1 Show the parts of the basic bracket backrest flag holder consisting of 2 brackets (A), a flag holder insertion tube (B), the upper holding clip (C), and the bolts to hold it all together (D), and the J bolts used to hold the assembled flag holder to the backrest of the motorcycle (E). The grooves in the brackets (E) and the hole in the tube (F) through which the bottom tube attachment bolt is located.

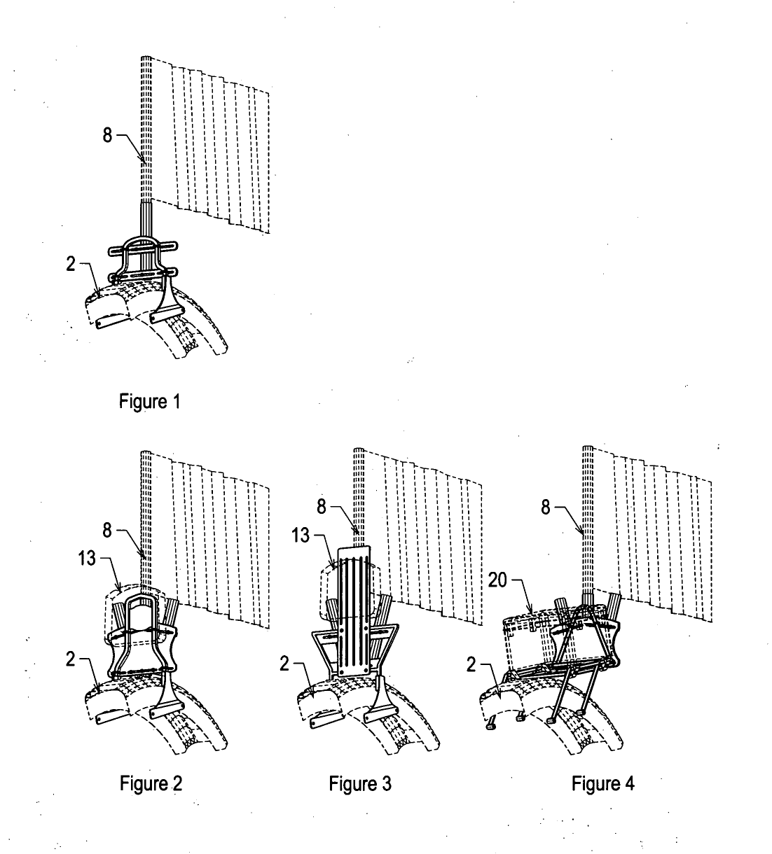

FIG. 2 Shows the assembled flag holder with the long bolt for the bottom of the tube holding the tube (A)to the lower bracket (B), and the upper clip (C) with the bolt holding it to the upper bracket (D).

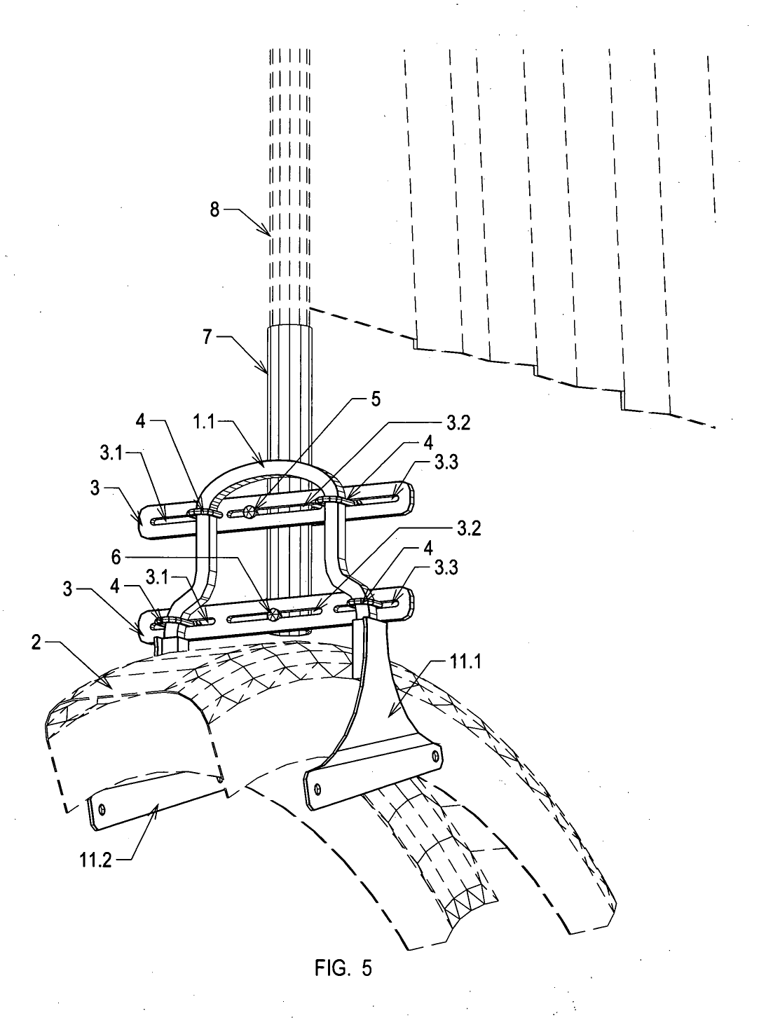

FIG. 3 shows the 2^{nd} iteration plate flag holder with the Plate (A) grooved top and bottom (B) to secure the tubes (C) to it. The holding clips (D), and again, the bolts to hold it all together and the J bolts (all as in FIG. 1. These are the same tubes and clips and bolts that are used throughout each iteration of flag holders.

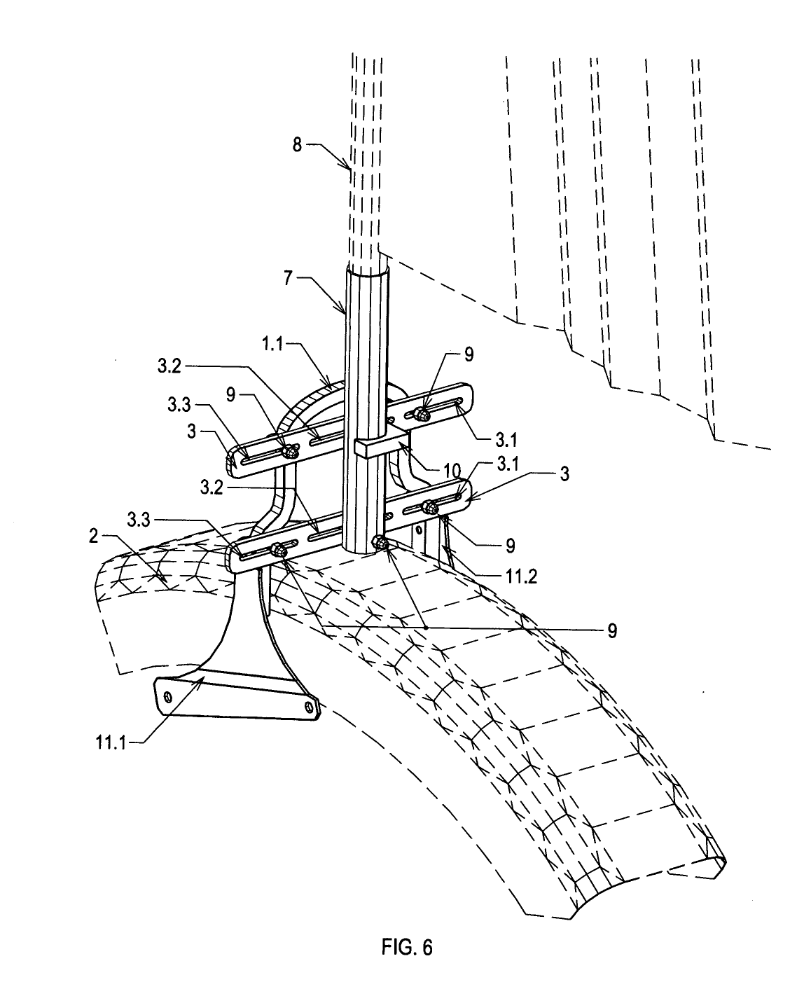

FIG. 4 Shows the 2^{nd} iteration flag holder of FIG. 3 bolted with J bolts again to the standard back rest frame of the motorcycle. The lower J bolts (A) can be seen hooked around the backrest frame.

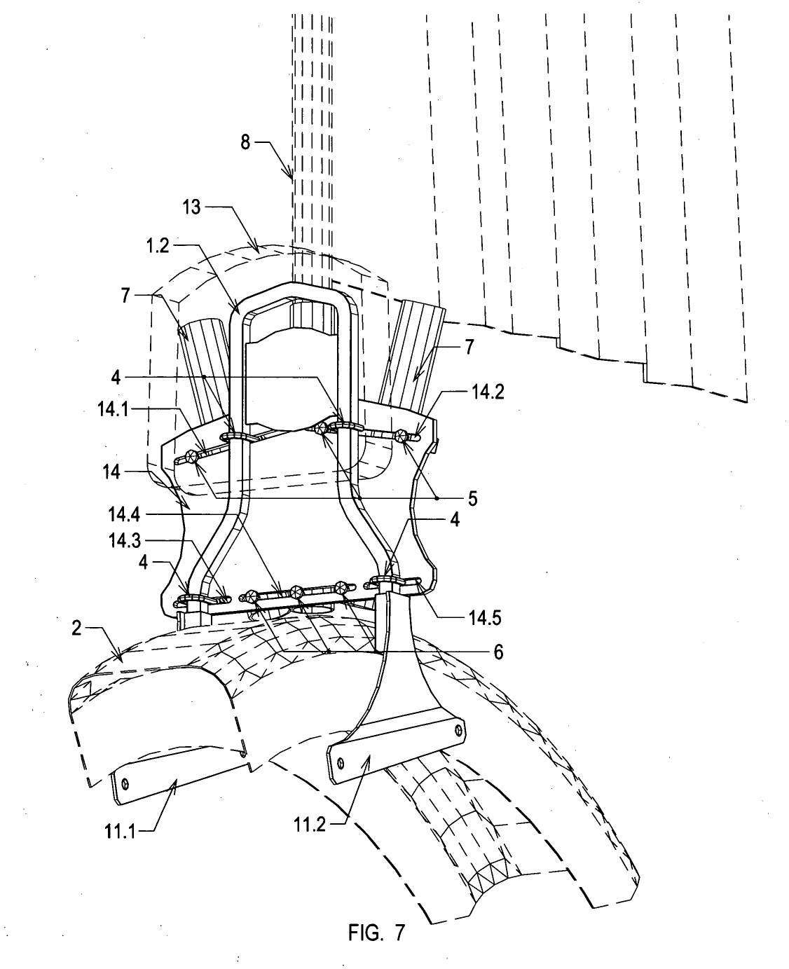

FIG. 5 shows the 3^{rd} iteration frame flag holder with the frame (A) with bolt holes drilled and tapped (B) to accept the back rest pad mounting plate (C). The frame has welded plates grooved as in the other iterations (D) to bolt on the tubes with the same hardware. In addition, it has the adjustable pad plate (E) which is drilled (F)to be bolted to the pre-tapped holes in the frame and grooved (G) to accommodate the bolts of the back rest pad. The grooves as we can see are vertical to allow for adjusting the positioning of the pad for best comfort.

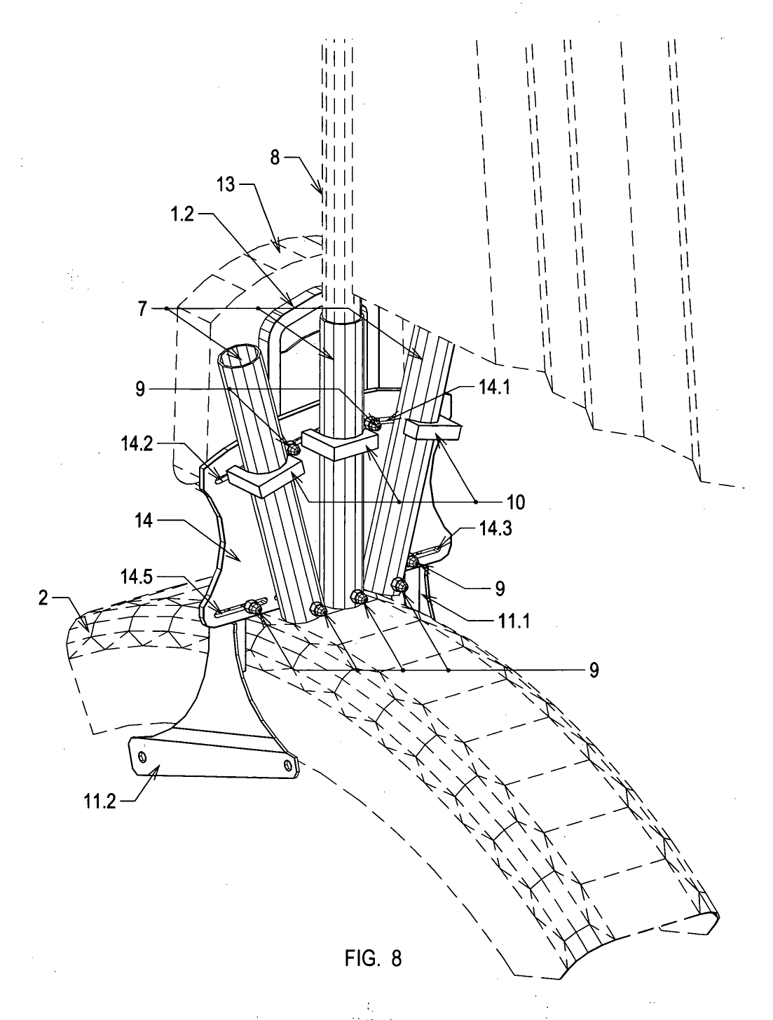

FIG. 6. Shows the frame flag holder iteration bolted together from the rear view.

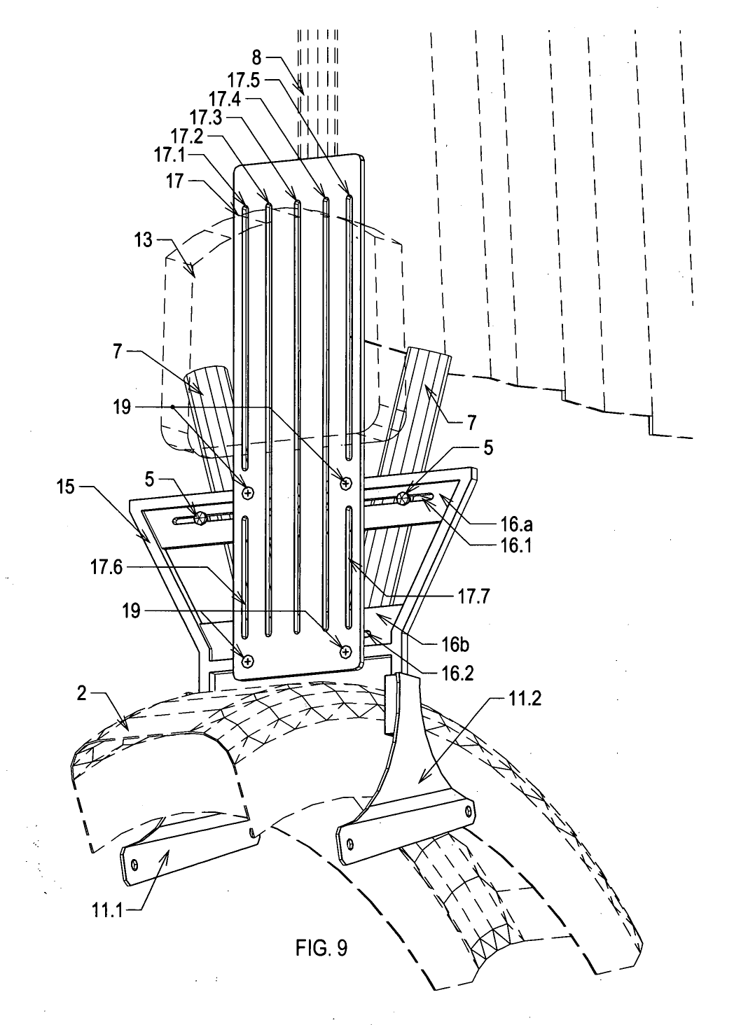

FIG. 7 shows the frame flag holder iteration from the front view. You will notice the bolts and nuts holding the tubes in place (A), the flat screws securing the adjustable back rest pad plate (B), and the feet (C) which fit into the standard backrest support sockets bolted to the frame, This unit replaces the entire back rest frame and holder shown in FIG. 4, thus providing an adjustable pad mount.

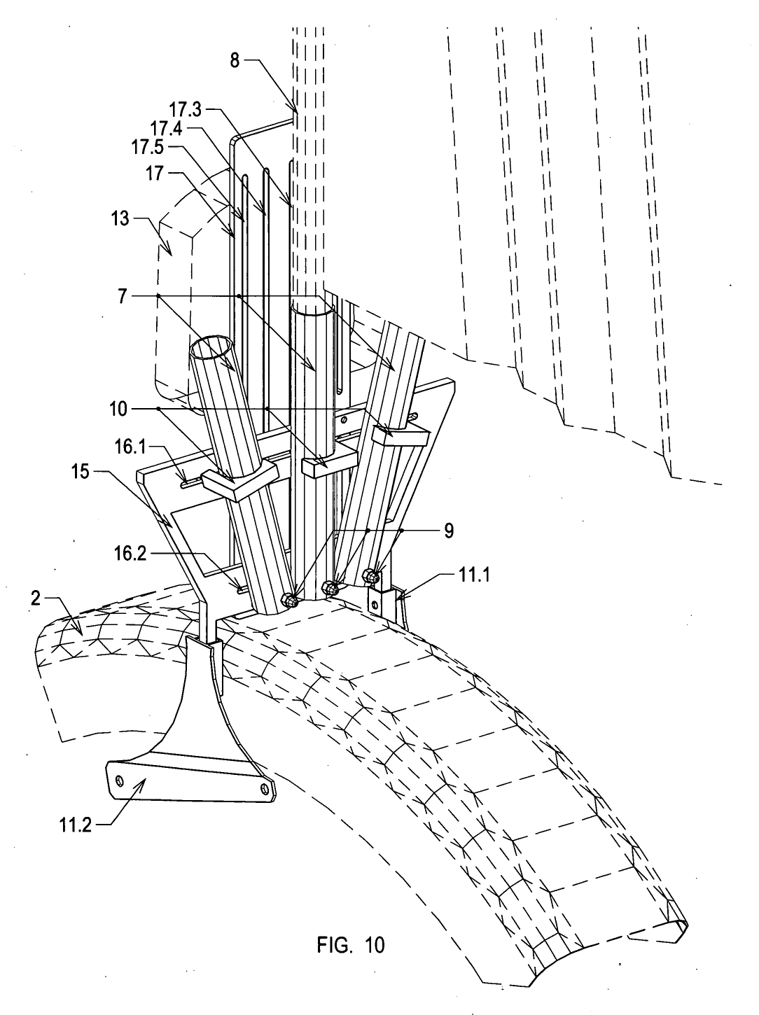

FIG. 8 shows the support bar used to mount the flag holders in either FIG. 1 or FIG. 3 on a motorcycle with a large storage box on the rear. It is seen sliding under the luggage box (A) where it is bolted or strapped to the underlying box support (B) so that the flag holder can be mounted on the exposed portion (C) just like it is on a back rest support frame.

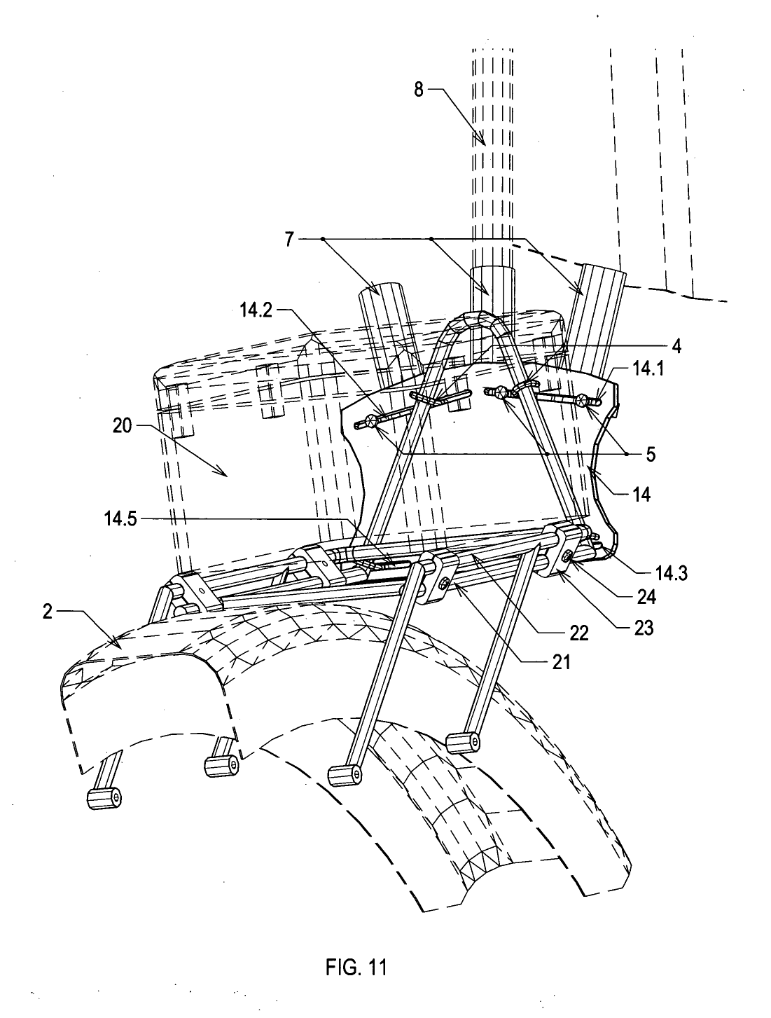

FIG. 9 shows the flag holder (A) mounted on a motorcycle with the flags on their poles which are slipped into the flag holder tubes (B).

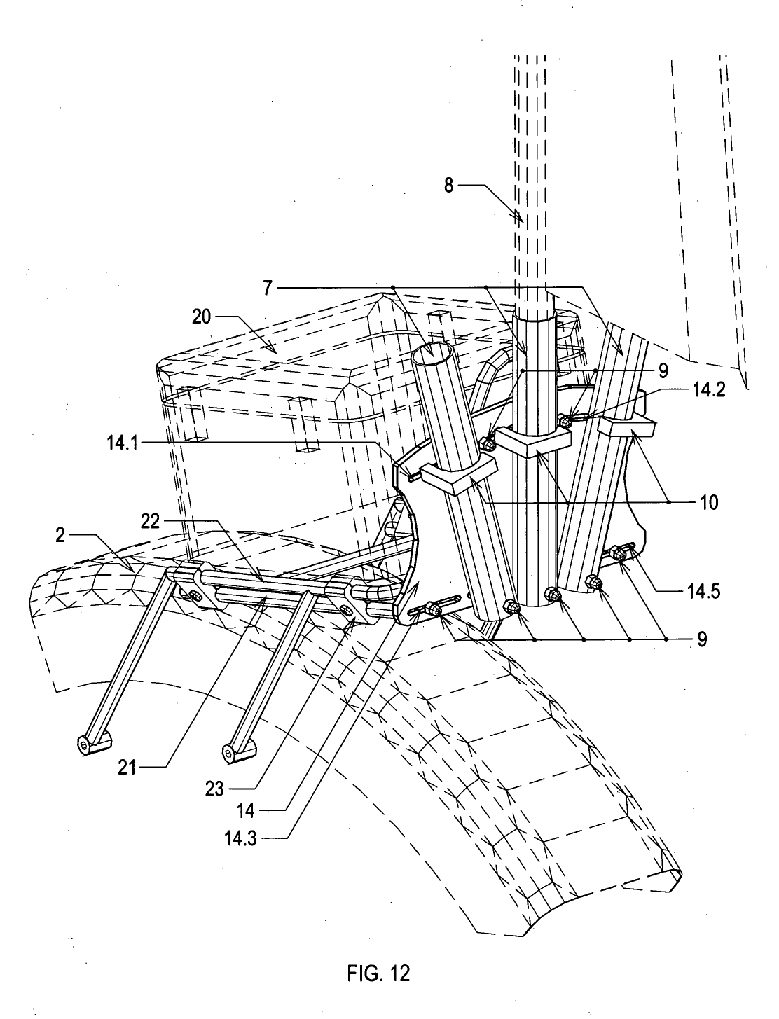

This concludes the figures and drawings

1. An invention for the mounting of one or more large flags on a motorcycle utilizing the standard backrest mount or mounting brackets of the motorcycle, in 3 iterations.

2. Iteration 1, A flag holder consisting of at least 2 brackets having a small width and long length which are grooved down much of the interior length. It includes tubes having a length which hold the flag pole or poles. The tubes are attached to the brackets at the bottom and up their length with bolts, clips, or clamps to hold them securely in an upright position. Bolts, clips, or clams are then positioned through the grooves in the brackets which then attach them to the standard back rest support tube or bar available from the motorcycle manufacturer or aftermarket supplier.

3. Iteration 2, A replacement of the brackets in claim 1 with a plate, grooved or drilled appropriately to hold the flag pole tubes in place, said plate bolted to the back rest support. Said plate having a height and width and being of sufficient thickness to hold the tubes to the plate and the plate to the backrest support solidly.

4. The third iteration is a frame, substituting for the standard back rest support frame and the flag pole tube holder brackets or plate, with legs protruding downward and a plate or plates welded or similarly attached within it. Said frame to be of tube or solid rod stock. The attached plates are grooved or drilled to provide attachment points for the bolts or clips holding the tubes of claim 1 firmly in place. The tubes are attached to the rearward side of said frame while a grooved plate is attached with bolts or clips to the front side The legs protruding downward are sufficient to slide into backrest frame supports attached to the motorcycle frame that are a standard add-on feature of most motorcycles and provided by the manufacturer or after market supplier.

5. That utilizing either grooves or bolt holes in the brackets, plate, or frame used in claims 2, 3, and 4 with allow singular or multiple flag holder tubes, and make them positionally adjustable through an infinite range.

6. That all flagpole holder iterations in claims 2, 3, and 4 are supplied with tubes with a length into which a flag pole or mast may be inserted. Said flag pole holders are of sufficient strength to securely hold a flagpole with full size flags at highway speeds.

7. That the flagpole tubes will have a stop through the bottom of the tube that may bolt to the brackets or plates, allowing the flag pole to be inserted and preventing it from going out of the bottom of the tube.

8. That, for those motorcycles without back rest support brackets to hold a tube or rod type frame for a back rest but having a luggage box with built in back rest on the rear of the motorcycle, an attachment bar for the flag holder in claims 2 and 3. Said bar to be of rod or tube of sufficient strength to hold the flag holders in claims 2 and 3 securely while bolting, strapping, or otherwise securing to the luggage box frame existent below the luggage box. Said tube or bar to be bent to such a shape as to protrude under the luggage box and next to the luggage box frame members, then coming out and up at a distance from the rear of the luggage box. Said bar to be bolted or strapped or otherwise secured to the luggage box frame at several points on each side of the frame beneath the luggage box. The flag holders in claims 2 and 3 are then bolted to this bar in the same manner as a backrest frame as described in claims 2 and 3.
